(19) United States
(12) Patent Application Publication
(10) Pub. No.: US 2014/0059283 A1
(43) Pub. Date: Feb. 27, 2014

(54) CONTROLLING A MEMORY ARRAY

(71) Applicant: James D. Dundas, Austin, TX (US)

(72) Inventor: James D. Dundas, Austin, TX (US)

(73) Assignee: ADVANCED MICRO DEVICES, INC., Sunnyvale, CA (US)

(21) Appl. No.: 13/593,343

(22) Filed: Aug. 23, 2012

(51) Int. Cl. G06F 12/00

(52) U.S. Cl. 711/104; 711/147; 711/E12.001

(57) ABSTRACT

Methods and systems for controlling a memory array are provided. A method of controlling a memory array includes: providing a next index to be read that indicates a location in the memory array from which to retrieve an output; reading validity information from a validity memory unit; comparing the next index with a last read index stored in an index memory unit; reading the output from an output memory unit when the last read index is the same as the next index and the validity information indicates the output in the output memory unit is valid; and reducing power to the memory array when the output is read from the output memory unit.

### TECHNICAL FIELD

The technical field relates generally to memory arrays in cache memories, and more particularly to storing and retrieving outputs of memory arrays from flops.

### BACKGROUND

Computer systems typically include a processing unit and one or more memory elements. For example, a typical computing device may include a combination of volatile and non-volatile memory elements to maintain data, program instructions, and the like that are accessed by a processing unit during operation of the computing device. A typical cache memory element may include a myriad of individual memory cells arranged in groups to define memory arrays. The arrays typically require energy to read or fetch information from the array. Some fetches from the array are repeated many times, such as in a cache that stores instructions for the processor. Accordingly, energy is often used to read the same information that was recently read from the array.

One solution for storing recently used fetches and avoiding powering the array is a loop buffer. A loop buffer is a large separate structure that attempts to capture the instructions that make up the body of a software loop. Loop buffers typically require complicated logic that detects when the processor is executing a loop that can fit within the loop buffer. Loop buffers also require a large amount of storage and logic to hold the instructions that make up the loop. This extra logic is large, prone to have bugs, and consumes both leakage and dynamic power. Furthermore, when executing typical code, the processor is not executing a loop that can fit in the loop buffer.

### SUMMARY OF EMBODIMENTS

In some embodiments, a method of controlling a memory array includes providing a next index to be read that indicates a location in the memory array from which to retrieve an output, comparing the next index with a last read index stored in an index memory unit, reading the output from an output memory unit when the last read index is the same as the next index, and reducing power to the memory array when the output is read from the output memory unit.

In some embodiments a computing system includes a memory array, power control logic, an index memory unit, an output memory unit, and array control logic. The memory array is configured to provide an output corresponding with a location in the memory array indicated by a next index to be read. The power control logic is configured to provide power to the memory array when the memory array is read from and to reduce power to the memory array when the memory array is not read from. The index memory unit is configured to store a last read index provided to the memory array. The output memory unit is configured to store the output of the memory array. The array control logic is configured to compare the next index with the last read index and to read the output from the output memory unit when the last read index is the same as the next index.

In some embodiments a computing system includes a memory array, power control logic, an index flop unit, and array control logic. The memory array is configured to provide an output corresponding with a location in the memory array indicated by a next index to be read and includes a plurality of static random access memory cells. The power control logic is configured to provide power to the memory array when the memory array is read from and to reduce power to the memory array when the memory array is not read from. The index flop unit is configured to store a last read index provided to the memory array. The output flop unit is configured to store the output of the memory array in at least one flop. The array control logic is configured to compare the next index with the last read index and to read the output from the output flop unit when the last read index is the same as the next index.

### BRIEF DESCRIPTION OF THE DRAWINGS

Advantages of the embodiments disclosed herein will be readily appreciated, as the same becomes better understood by reference to the following detailed description when considered in connection with the accompanying drawings wherein:

FIG. 1 is a simplified block diagram of a computing system according to some embodiments;

FIG. 2 is a simplified block diagram of an array unit according to some embodiments; and

FIG. 3 is a flow diagram illustrating a method of controlling a memory array according to some embodiments.

### DETAILED DESCRIPTION

The following detailed description is merely exemplary in nature and is not intended to limit application and uses. As used herein, the word “exemplary” means “serving as an example, instance, or illustration.” Thus, any embodiments described herein as “exemplary” are not necessarily to be construed as preferred or advantageous over other embodiments. All of the embodiments described herein are exemplary embodiments provided to enable persons skilled in the art to make or use the disclosed embodiments and not to limit the scope of the disclosure which is defined by the claims. Furthermore, there is no intention to be bound by any expressed or implied theory presented in the preceding technical field, background, brief summary, the following detailed description or for any particular computer system.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below as being “connected,” these elements may be “coupled,” and vice versa. Thus, although the block diagrams shown herein depict example arrangements of elements, additional intervening elements, devices, features, or components may be present in actual embodiments.

Finally, for the sake of brevity, conventional techniques and components related to computer systems and other functional aspects of a computer system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in the embodiments disclosed herein.

In some embodiments, an improved system and method for controlling memory arrays is provided. Other desirable features and characteristics of the disclosed embodiments will become apparent from the subsequent detailed description and the appended claims, taken in conjunction with the accompanying drawings.

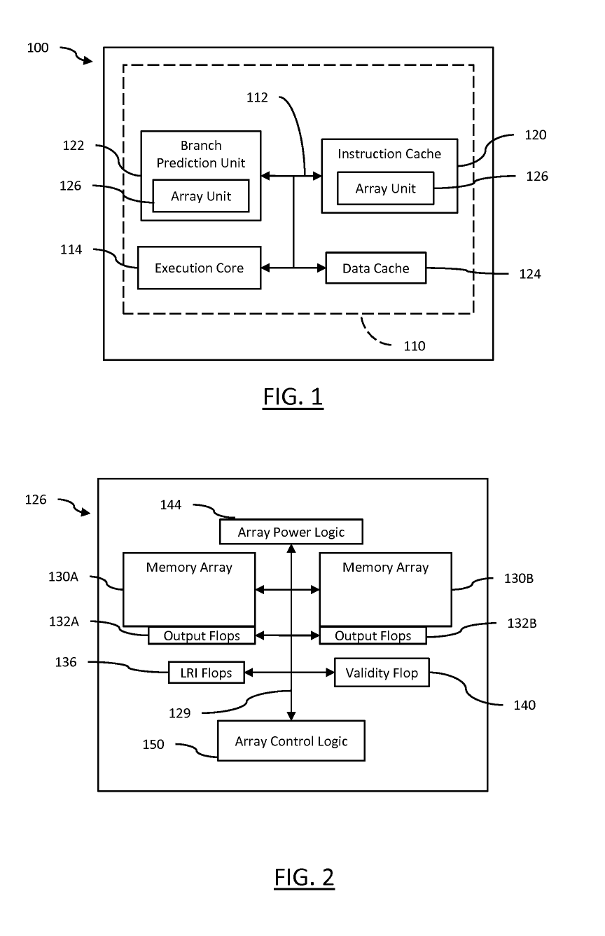

Referring to FIG. 1, a generalized block diagram of a computing system 100 having a processor 110, according to some embodiments, is shown. The computing system 100 may be a desktop computer, laptop computer, server, set top box, digital television, printer, camera, motherboard, or any other device that includes the processor 110. It should be understood that FIG. 1 is a simplified representation of a computing system 100 for purposes of explanation and ease of description, and FIG. 1 is not intended to limit the subject matter in any way. Practical embodiments of the computing system 100 may include other devices and components for providing additional functions and features. For example, various embodiments of the computing system include components such as input/output (I/O) peripherals, memory, interconnects, and memory controllers. Furthermore, the computing system 100 may be part of a larger system, as will be understood.

Processor 110 includes circuitry for executing instructions according to a predefined instruction set architecture (ISA). For example, the x86 instruction set architecture may be selected. In some embodiments, processor 110 is included in a single-processor configuration. In some embodiments, processor 110 is included in a multi-processor configuration. The processor 110 includes an interconnect 112, an execution core 114, an instruction cache 120, a branch prediction unit 122, and a data cache 124. In some embodiments, processor 110 include two or more execution cores 114. It should be appreciated that the processor 110 may include additional features and may have configurations and component hierarchies other than shown in FIG. 1. The interconnect 112 electronically couples the execution core 114, the instruction cache 120, the branch prediction unit 122, and the data cache 124. The execution core 114 retrieves and executes instructions from the instruction cache 120 on data from the data cache 124.

Caches 120, 124 are integrated within the processor 110 in the illustrated embodiments. Alternatively, caches 120, 124 may have other configurations or be implemented in various hierarchies of caches.

The instruction cache 120 stores instructions for a software application in a plurality of array units 126, as will be described below with reference to FIG. 2. The instructions may be stored in the contiguous bytes of instructions and may include one or more branch instructions.

The branch prediction unit 122 is configured to predict the flow of an instruction stream and store the prediction as prediction information in a plurality of array units 126. The branch prediction unit 122 may include sparse arrays, dense arrays, dynamic indirect arrays, or other arrays. For example, a 1-bit value may indicate a prediction of whether a condition is satisfied that determines if a next sequential instruction should be executed, or alternatively if an instruction in another location in the instruction stream should be executed. The prediction information may also include an address of a next instruction to execute that differs from the next sequential instruction. The determination of the actual outcome and whether or not the prediction was correct may occur in a later pipeline stage.

Referring now to FIG. 2, the array unit 126 is illustrated in block diagram form. It should be appreciated that the features of the array unit 126 may be applied to any memory array of the processor 110. The array unit 126 includes an interconnect 129, a first memory array 130A, a first plurality of output flops 132A, a second memory array 130B, a second plurality of output flops 132B, a plurality of last read index (LRI) flops 136, a validity flop 140, array power logic 144, and array control logic 150. The interconnect 129 couples the components of the array unit 126 for electronic communication. It should be appreciated that alternative configurations and hierarchies may be used to electronically couple the components of the array unit 126.

The memory arrays 130A-B generally include static random access memory (SRAM) cells that each store a bit that is either set or cleared, where “set” means that that the cell is logic high and “cleared” means that the cell is logic low. Alternatively, “set” may mean that the cell is logic low and “cleared” may mean that the cell is logic low. The memory arrays 130A-B are configured to provide an output block of information corresponding with a location in the memory array indicated by an index. Each of the memory arrays 130A-B includes a read enable gate that is energized to read from the array. The read enable gate may be provided with reduced or no power when no output is needed from the arrays 130A-B. It should be appreciated that the memory arrays 130A-B may include other types of cells, may have other configurations, and may include other technologies.

The output flops 132A-B are coupled to and store the output of the memory arrays 130A-B, respectively. Accordingly, the output flops 132A-B may be considered single entry L0 caches to provide the previous output from the memory arrays 130A-B without energizing the read enable gate of the memory arrays 130A-B. The output flops 132A-B include clock gates (not shown) that control whether the output flops 132A-B will store or ignore the output from the memory arrays 130A-B. For example, when the memory arrays 130A-B are in a low power state, the clock gates of the output flops 132A-B are not energized and no new data is written to the output flops 132A-B. Similarly, when the output is read from the memory arrays 130A-B, the clock gates of the output flops 132A-B are energized to store the output in the output flops 132A-B. In the example provided the output flops 132A-B are internal to the arrays 130A-B to share common output pins. In some embodiments, the output flops 132A-B are external to the arrays 130A-B. Furthermore, in some embodiments the output flops 132A-B store multiple entries from the previous several reads of the memory arrays 130A-B. For example, the output flops 132A-B may be configured as a multiple entry fully associative cache that holds the recent fetches from the array.

The LRI flops 136 store a previous index. The previous index is the read index that was last read from in the memory arrays 130A-B. The LRI flops 136 may store a full or partial index that corresponds with one or more memory arrays. For example, in some embodiments each of the LRI flops stores a wide read index of a potential access of a group of four arrays that provide a block or sequence of 32 bytes.

The validity flop 140 stores validity information that indicates whether the output stored in the output flops 132A-B still corresponds to the information stored at the index location on the array 130A-B. The validity flop 140 may be in a first state that indicates the output stored in the output flops 132A-B is valid or may be in a second state that indicates the output stored in the output flops 132A-B may not be valid. In the example provided, the validity flop 140 is cleared to the second state (e.g., binary logic low) when information is written the memory arrays 130A-B and is set to the first state (e.g., binary logic high) when the output is read from the memory arrays 130A-B and saved to the output flops 132A-B. Accordingly, even when the LRI flops 136 indicate that location in the arrays 130A-B is the same as the last read, the output is not read from the output flops 132A-B because the location indicated by the index may contain information that is different from what was read at that index during the last read.

In some embodiments, on each write to the array the index of the write is stored in the LRI flops and the information written to the array is stored in the output flops. The validity flop 140 in these embodiments may be set to the first state on the write or the validity flop 140 may be omitted.

The array power logic 144 is configured to provide power to the memory array when reading from the memory array and to reduce power to the memory array when not reading from the memory array. For example, the array power logic 144 may energize the enable read gate of the arrays 130A-B when reading from the arrays 130A-B and may reduce power to or refrain from energizing the read enable gate when the output is to be read from the output flops 132A-B. Therefore, power consumption is reduced when the output is read from the output flops 132A-B, such as during instruction loops. Accordingly, the array power logic 144 shuts down the arrays 130A-B of the instruction cache 120 while a pattern of instruction fetches remains within the output flops 132A-B.

The array control logic 150 is configured to determine whether the output flops 132A-B contain the desired information to be read from the next index location. The array control logic 150 reads from the output flops 132A-B when the validity flop 140 is in the first state and the next index is the same as the previous index stored in the LRI flops 136. The array control logic 150 reads the memory arrays 130A-B when either the validity flop 140 is in the second state or the next index does not match the previous index stored in the LRI flops 136. In the example provided the validity flop 140 and the LRI flops 136 are checked in the clock cycle before the access is performed. Accordingly, the same amount of time is taken to read from the arrays 130A-B or the output flops 132A-B. It should be appreciated that the output flop 132A-B reads may be performed at other times or may be provisionally read and discarded when a later check determines the desired output may not be stored in the output flops 132A-B. For the instruction cache 120, the array control logic 150 compares the last read index to all possible fetch targets, such as predicted taken branches, sequential accesses, or other suitable fetch targets.

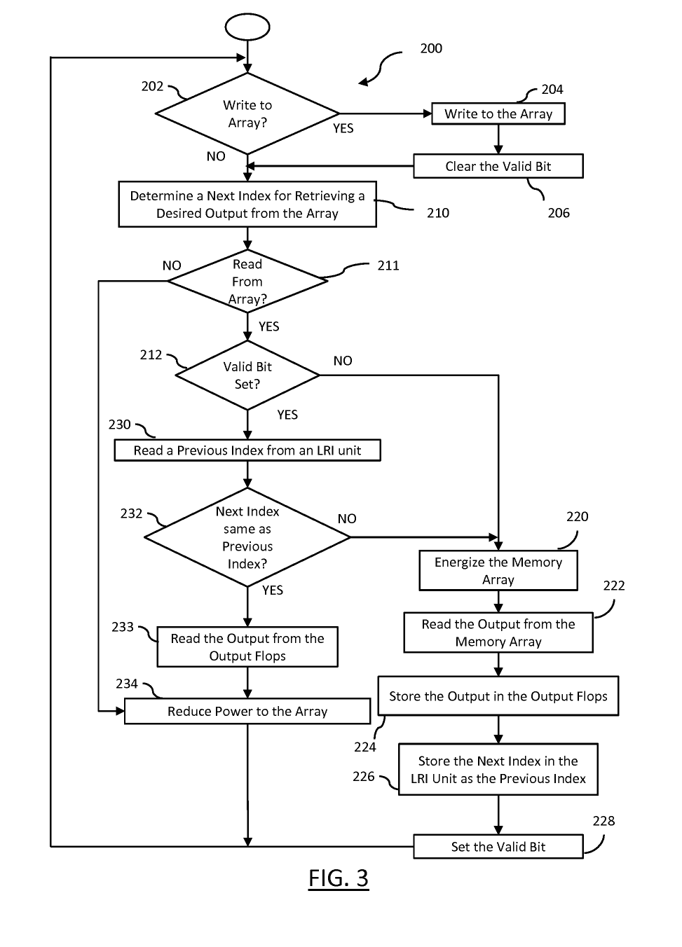

Referring now to FIG. 3, a flow diagram illustrates a method 200 of controlling a memory array according to some embodiments. At step 202 a memory controller determines whether data is to be written to the array. For example, when new instructions are brought into the instruction cache 120. When no data is to be written to the array, the method proceeds to step 210. When data is to be written to the array, the data is written to the array in step 204 and a valid bit is cleared in step 206. For example, the valid flop 140 may be cleared or otherwise instructed to store validity information indicating whether the array has been written to. It should be appreciated that steps 202, 204, 206 may be performed at any time in the method 200.

At step 210 a next index for retrieving a desired output from the array is determined. The next index is a sequence of binary numbers that provides a physical address in the memory array where the desired output is to be found. For example, the array control logic 150 may determine the next index to be read from the memory arrays 130A-B.

At step 211 it is determined whether the array is to be read from. For example, an external read signal may indicate whether a processor needs to read from the array in a given cycle. When the array is to be read from in the cycle, the method proceeds to step 212 and when the array is not to be read from the method proceeds to step 234.

At step 212 the status of the valid bit or other validity information is determined. The valid bit or validity information generally indicate whether the memory array has been written to since the output flops 132A-B were last written to. When the valid bit is set to logic state high, the method proceeds to step 230, as will be described below. When the valid bit is cleared to logic state low, the method proceeds to step 220. For example, the method proceeds to step 220 when the valid flop 140 indicates that the valid bit is cleared or otherwise stores validity information that indicates that the array 130A-B has not been has not been read from since the last write.

The memory array is energized at step 220 and the output from the memory array corresponding with the next index is read at step 222. The output is stored in step 224. In the example provided, the array control logic 150 reads the output and the output flops 132A-B store the output at the same time.

The next index that was just read from in step 222 is then stored in step 226 and the valid bit is set in step 228. For example, the next index may be stored in the LRI flops 136 as a previous index and the valid bit or other validity information may be stored in the valid flop 140. The method then returns to step 202 to determine whether data is to be written to the array.

When step 212 indicates that the valid bit is set to logic high, the method proceeds to step 230 where a previous index is read. The previous index is then compared with the next index to be read in step 232. For example, the LRI flops 136 may be read to retrieve the previous index that was stored in step 226. When the next index is different from the previous index, the method proceeds to step 220 to energize and read from the memory array, as described above. The next index is different from the previous index when the physical address in an array or group of arrays indicated by the next index is different from the physical address in the array or group of arrays indicated by the previous index.

When the next index is the same as the previous index, the method proceeds to step 233 to read the output flops and step 234 to reduce power to the memory array. The next index is the same as the previous index when the next index and previous index both indicate the same physical address in the array or group of arrays to be read from. It should be appreciated that the memory array may already be in a low power state and step 234 may simply maintain the low power state of the memory array. Additionally, steps 233 and 234 may be performed concurrently. Generally, steps 212 and 232 confirm that the output flops 132A-B are storing the information that is currently stored at the physical address indicated by the next index of the memory array. Accordingly, the output is read from the output flops 132A-B in step 233, power is reduced to the memory array in step 234, and the method returns to step 202.

A data structure representative of the computer system 100 and/or portions thereof included on a computer readable storage medium may be a database or other data structure which can be read by a program and used, directly or indirectly, to fabricate the hardware comprising the computer system 100. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the computer system 100. The netlist may then be placed and routed to produce a data set describing geometric shapes to be applied to masks. The masks may then be used in various semiconductor fabrication steps to produce a semiconductor circuit or circuits corresponding to the computer system 100. Alternatively, the database on the computer readable storage medium may be the netlist (with or without the synthesis library) or the data set, as desired, or Graphic Data System (GDS) II data.

The method illustrated in FIG. 3 may be governed by instructions that are stored in a non-transitory computer readable storage medium and that are executed by at least one processor of the computer system 100. Each of the operations shown in FIG. 3 may correspond to instructions stored in a non-transitory computer memory or computer readable storage medium. In various embodiments, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

Embodiments have been described herein in an illustrative manner, and it is to be understood that the terminology which has been used is intended to be in the nature of words of description rather than of limitation. Obviously, many modifications and variations are possible in light of the above teachings. Various implementations may be practiced otherwise than as specifically described herein, but are within the scope of the appended claims.

What is claimed is:

1. A method of controlling a memory array, the method comprising:
providing a next index to be read that indicates a location in the memory array from which to retrieve an output;
comparing the next index with a last read index stored in an index memory unit;
reading the output from an output memory unit when the last read index is the same as the next index; and
reducing power to the memory array when the output is read from the output memory unit.

2. The method of claim 1 further including increasing power to the memory array and reading the output from the memory array when the last read index is different from the next index.

3. The method of claim 2 further including storing the output in the output memory unit and storing the next index in the index memory unit as the last read index when the last read index is different from the next index, and wherein the output memory unit is configured to store the output of the memory array.

4. The method of claim 1 further including reading validity information from a validity memory unit and reading the output from the memory array when the validity information indicates that the memory array has been written to since the output memory unit was last written to.

5. The method of claim 4 wherein comparing the next index with the last read index includes comparing the next index with the last read index when the validity information indicates that the memory array has not been written to since the output memory unit was last written to.

6. The method of claim 4 further including writing the validity information to the validity memory unit when the memory array is written to and when the output memory unit is written to.

7. The method of claim 1 further including writing information to the memory array at a write index, storing the information in the output memory unit, and storing the write index in the index memory unit as the last read index.

8. A computing system comprising:
a memory array configured to provide an output corresponding with a location in the memory array indicated by a next index to be read;
power control logic configured to provide power to the memory array when the memory array is read from and to reduce power to the memory array when the memory array is not read from;
an index memory unit configured to store a last read index provided to the memory array;
an output memory unit configured to store the output of the memory array;
array control logic configured to compare the next index with the last read index and to read the output from the output memory unit when the last read index is the same as the next index.

9. The computing system of claim 8 further including a validity memory unit including a first and a second state, wherein the first state indicates that the output stored in the output memory unit is valid and the second state indicates that the output stored in the output memory unit may not be valid.

10. The computing system of claim 9 wherein the validity memory unit is configured to be in the second state when the memory array has been written to since the output was last read.

11. The computing system of claim 9 wherein the array control logic is further configured to read the output from the memory array when the validity memory unit is in the second state.

12. The computing system of claim 9 wherein the array control logic is further configured to compare the next index with the last read index when the validity memory unit is in the first state.

13. The computing system of claim 8 wherein the validity memory unit and the index memory unit each include at least one flop.

14. The computing system of claim 8 wherein the memory array includes a plurality of static random access memory cells and the output memory unit includes a plurality of flops.

15. The computing system of claim 8 wherein the array control logic is further configured to write information to the memory array at a write index, store the information in the output memory unit, and store the write index in the index memory unit as the last read index.

16. A computing system comprising:
a memory array configured to provide an output corresponding with a location in the memory array indicated by a next index to be read, wherein the memory array includes a plurality of static random access memory cells;
a power control logic configured to provide power to the memory array when the memory array is read from and to reduce power to the memory array when the memory array is not read from;
an index flop unit configured to store a last read index provided to the memory array;
an output flop unit configured to store the output of the memory array in at least one flop;
an array control logic configured to compare the next index with the last read index and to read the output from the output flop unit when the last read index is the same as the next index.

17. The computing system of claim 16 further including a validity flop unit including at least one flop that indicates a first and a second state of the validity flop unit, wherein the first state indicates that the output stored in the output flop unit is valid and the second state indicates that the output stored in the output flop unit may not be valid.

18. The computing system of claim 17 wherein the validity flop unit is configured to be in the second state when the memory array has been written to since the output was last read.

19. The computing system of claim 17 wherein the array control logic is further configured to read the output from the memory array when the validity flop unit is in the second state.

20. The computing system of claim 17 wherein the array control logic is further configured to compare the next index with the last read index when the validity flop unit is in the first state.
